(19) United States
(12) Patent Application Publication
(10) Pub. No.: US 2016/0302616 A1
(43) Pub. Date: Oct. 20, 2016

(54) WOOD RAILING BARBECUE GRILL

(71) Applicant: H. Darren Brock, Lexington, NC (US)

(72) Inventor: H. Darren Brock, Lexington, NC (US)

(21) Appl. No.: 14/687,455

(22) Filed: Apr. 15, 2015

(51) Int. Cl. A47J 37/07

(52) U.S. Cl. CPC A47J 37/0763

(57) ABSTRACT

The present invention provides a barbecue system for mounting on a wood railing on a deck. By providing a mounting arm, a support leg, and a fire shield, a grill can be safely mounted and free up the deck space.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a barbecue grill. In particular, it relates to a barbecue grill useful for mounting on a wood rail fence.

2. Description of Related Art

The art of grilling or barbecuing has become a prevalent means of cooking, especially in the summer. It is usually accomplished outdoors, and grilling happens at parks and recreation areas around the country. Probably the most common place to grill/barbecue is at one's home. Most gas, charcoal and wood grills are designed with the thought that they will be used outside and at the owner's home. A grill consists of a firebox, some sort of support, and can include a cover or the like. It's adapted to accept one or more of a gas, wood or charcoal fuel. The grills can be portable, built in, and, more frequently, free standing.

The location one places the grill at one's home depends on many factors, but generally it is at the rear of the house. This depends on if the owner has a patio, a balcony, a deck, or some other type of structure. No matter what type of situation the grill is utilized under, the grill takes up space, especially on a deck, and finding ways of freeing up deck space when one has a grill of some kind has become common. In addition, there's a safety issue with a grill close to a wooden deck. Users will place the grill farther away from the house in an attempt to free up the deck space. In some instances, individuals have built cantilevered spaces on the opposite side of the deck fencing, but again it creates a safety issue so close to the wooden fencing. Yet another problem is that most deck fencing is wood, and normally that means placing the grill away from the deck fence to prevent a fire, thus wasting even more room, as nothing can be done with the space between the grill and the deck fence. Where a fence is metal (such as on a balcony where metal handrails are common) fire is not an issue with grill use, but most decks have a wood or vinyl rail system which is heat sensitive, and frequently the remainder of the fence is wood or vinyl. A grill design that clears up deck space, is useful on deck fencing, and is also heat and fire sensitive is not currently available.

### BRIEF SUMMARY OF THE INVENTION

The problems outlined above and more can be solved, or at least ameliorated, by the present invention. This grill is safer to use on a wood deck or railing than previous grills. In the present invention, by hanging a grill on a wooden railing, adding a fire shield and a support leg connecting the grill and fence, the objects of the present invention can be achieved.

In one embodiment, the present invention relates to a barbecue grill for attachment to a wooden or plastic handrail of a deck fence, the grill comprising:
a) a barbecue grill;
b) a mounting arm which attaches to the grill at its proximal end and mounts over the handrail at the distal end such that the mounting arm holds the grill in spaced relationship to the deck fence;
c) a support leg for attaching to a bottom portion of the grill at a proximal end and to a lower portion of the deck fencing at a distal end; and
d) a fire shield which mounts on the deck fencing in between the deck fencing and the grill.

### BRIEF DESCRIPTION OF THE DRAWINGS

FIG. 1 is a side view of the grill mounted on a wood railing.

FIG. 2 is a perspective view of the grill mounted on a wood railing of a deck.

FIG. 3 shows the spacer/rail attachment.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the phrase “barbecue grill” refers to a firebox burning a fuel, such as wood, charcoal or gas, for the purpose of cooking food on a metal grill. This “barbecue grill” usually includes a cover or the like, and is well-known within those skilled in the art. In general, the firebox heats up to a high enough temperature to damage or cause fire with plastics or wood that comes close or in contact with the firebox.

As used herein, the phrase “wooden or plastic handrail” refers to the top bar on a deck fence. On deck fencing these can be made of a number of materials, but the invention is designed to be used with standard handrails made of heat sensitive or heat damageable materials. These materials include various types of wood (including heat treated), and plastics (such as vinyl), but other materials would be understood by one of skill in the art and are included in this definition.

As used herein, the phrase “deck fence” refers to a wooden deck on the back of a dwelling or other building, designed to provide a level surface where the ground is either not level or is too far below the back door to be utilized by the user of the building. Such decks and deck fencing are well known in the art.

As used herein, the terms “mounting arm” and “attachment” refer to one or more arms attached at a proximal end to the grill by general means such as bolting or welding or the like. At its distal end there is a portion which fits over the handrail (such as shown in the figures) in order to attach the grill to the handrail. The arm is long enough to create a spaced relationship between the handrail, the fence, and the grill itself. The arm could create a separation of 2, 3, 4, 5, 6, 12 or more inches. The mounting arm can sit on the handrail by gravity, or be screwed, or otherwise made to be attached in a temporary or permanent way. In one embodiment, there are one or more thumb screws on a side of the arm distal most from the grill which screw into the handrail for attachment. In one embodiment, the arm proximal end has a shelf which the grill sits on, thus making it removable and so, for purposes herein, attachment also includes to a shelf where the grill sits thereon.

As used herein, the phrase “support leg” refers to one or more legs attached to the bottom portion (the bottom of the grill or lower area on the front of the grill) via the proximal end of the leg and the distal end being attached to the deck fence by screws or other attachment means. In one embodiment, the leg is attached to the posts of the fence.

As used herein, the phrase “fire shield” refers to material positioned on or near the fence itself, in-between the fence and the grill (see figures) which protect the rail and sensitive parts of the fence from the heat of the grill. The shield can be metal or other fire resistant materials known in the art. The size of the shield will depend on how close the grill is mounted and how big it is, but one skilled in the art can make it wide enough and long enough to produce protection. In one embodiment, it is attached to the mounting arm. In another embodiment, it is positioned to protect the fence railing.

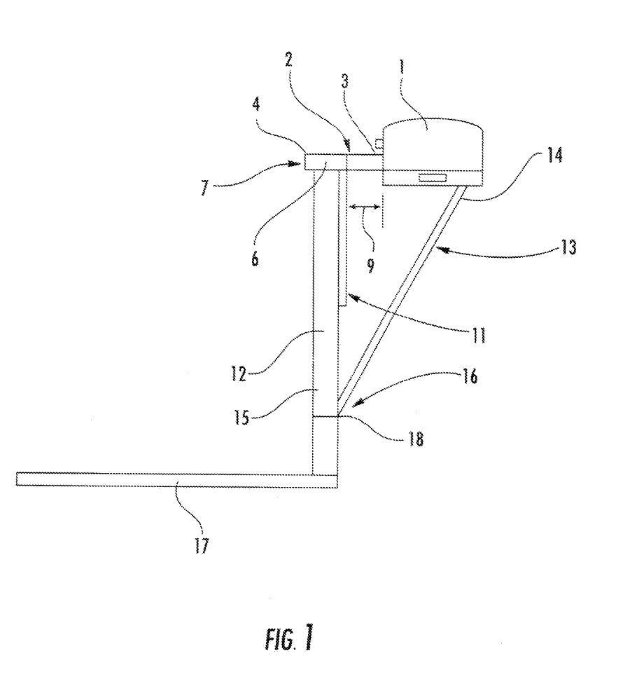

Now referring to the drawings, FIG. 1 is a side view of the present invention. Barbecue grill 1 has mounting arm 2 having a proximal end 3 and a distal end 4 mounted over railing 6 and held in place by screw 7 which screws into railing 6. The mounting arm 2 creates a distance 9 in between grill 1 and railing 6. Also shown is fire shield 11 mounted to fence 12, which is positioned between grill 1 and fence 12 and railing 2. Shown in this view is the support leg 13 which attaches to the lower portion of the grill 1 at its proximal end 14 and attached to a fence post 15 at its distal end 1 with screw 18 above the wooden deck 17.

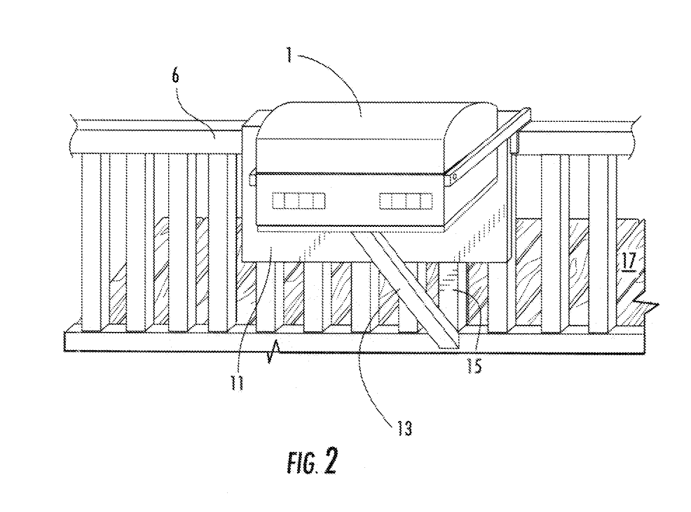

In FIG. 2 we have a perspective view of the grill with the same view except the support arm is mounted lower on the fence post 15 and on the front of the grill on the lower portion of grill 1.

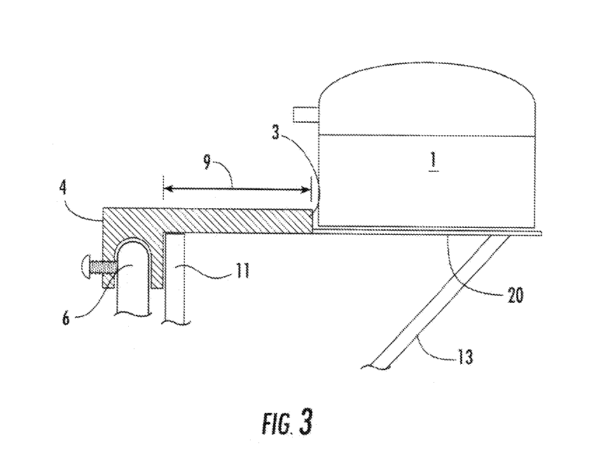

FIG. 3 shows an embodiment of the invention from a close-up side view perspective of just the mounting spacing arm wherein there is a shelf 20 wherein the grill 1 sits on the shelf 20 and the attachment of the arm's proximal end is to the shelf, but considered to the grill for language purposes. The support arm can, in this embodiment, be connected to the shelf, which for purposes of the invention is the lower portion of the grill when a shelf is utilized.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A barbecue grill for attachment to a wooden or plastic handrail of a deck fence, the grill comprising:
a) a barbecue grill;
b) a mounting arm which attaches to the grill at its proximal end and mounts over the handrail at the distal end such that the mounting arm holds the grill in spaced relationship to the deck fence;
c) a support leg for attaching to a bottom portion of the grill at a proximal end and to a lower portion of the deck fencing at a distal end; and
d) a fire shield which mounts on the deck fencing in between the deck fencing and the grill.

2. The barbecue grill according to claim 1 wherein the mounting arm attaches to the wooden rail by means of a screw.

3. The barbecue grill according to claim 1 wherein the fire shield is metal or a fire insulating material.

4. The barbecue grill according to claim 1 wherein the distal end of the support leg is attached to a lower position of a post in the deck fence.
